(19) United States
(12) Patent Application Publication
(10) Pub. No.: US 2003/0187730 A1
(43) Pub. Date: Oct. 2, 2003

(54) System and method of measuring exposure of assets on the client side

(76) Inventors: Jai Natarajan, Sunnyvale, CA (US); Simon Gibbs, San Jose, CA (US)

Correspondence Address: Valley Oak Law, 5655 Silver Creek Valley Road, #106, San Jose, CA, 95138, US

(21) Appl. No.: 10/109,491

(22) Filed: Mar. 27, 2002

(51) Int. Cl. G06F 17/60

(52) U.S. Cl. 705/14; 707/200

(57) ABSTRACT

The invention illustrates a system and method measuring visibility of viewing assets on the client side comprising: a content stream; a metadata stream corresponding to the content stream for describing the content stream; and a capture module configured for monitoring the metadata stream for a target subject and capturing a parameter associated with the target subject.

### FIELD OF THE INVENTION

The invention relates generally to the field of audio/visual content, and more particularly measuring exposure of assets within the audio/visual content.

### BACKGROUND OF THE INVENTION

Companies spend substantial sums of money and resources to promote their products and/or services. Effective advertising campaigns can help companies sell their products and/or services. Ineffective advertising campaigns can squander away assets of a company. Judging the effectiveness of advertising can be costly and inaccurate.

Advertising budgets are often spent in reliance of Nielson ratings or other rating sources which cannot confirm that the target audience actually viewed the advertising. These ratings only confirm the ideal number of the potential audience that were available to view the advertising asset.

Some companies track advertisement exposure by the number of click or hits for their Internet advertising. However, the number clicks does not confirm that each click was from a different individual viewing the advertising asset. Further, the number of clicks does not provide additional data reflecting the amount of time the individual spent viewing the advertising asset. Additionally, the number of clicks does not provide additional data reflecting the size of the advertising asset as viewed by the user.

### SUMMARY OF THE INVENTION

The invention illustrates a system and method measuring visibility of viewing assets on the client side comprising: a content stream; a metadata stream corresponding to the content stream for describing the content stream; and a capture module configured for monitoring the metadata stream for a target subject and capturing a parameter associated with the target subject.

Other aspects and advantages of the invention will become apparent from the following detailed description, taken in conjunction with the accompanying drawings, illustrated by way of example of the principles of the invention.

### BRIEF DESCRIPTION OF THE DRAWINGS

FIG. 1 illustrates one embodiment of an audio/visual production system according to the invention.

FIG. 2 illustrates an exemplary audio/visual content stream according to the invention.

FIG. 3 illustrates one embodiment of an audio/visual output system according to the invention.

FIG. 4 illustrates a flow diagram utilizing a trigger according to the invention.

FIG. 5 illustrates a flow diagram utilizing a capture module according to the invention.

### DETAILED DESCRIPTION

Specific reference is made in detail to the embodiments of the invention, examples of which are illustrated in the accompanying drawings. While the invention is described in conjunction with the embodiments, it will be understood that the embodiments are not intended to limit the scope of the invention. The various embodiments are intended to illustrate the invention in different applications. Further, specific details are set forth in the embodiments for exemplary purposes and are not intended to limit the scope of the invention. In other instances, well-known methods, procedures, and components have not been described in detail as not to unnecessarily obscure aspects of the invention.

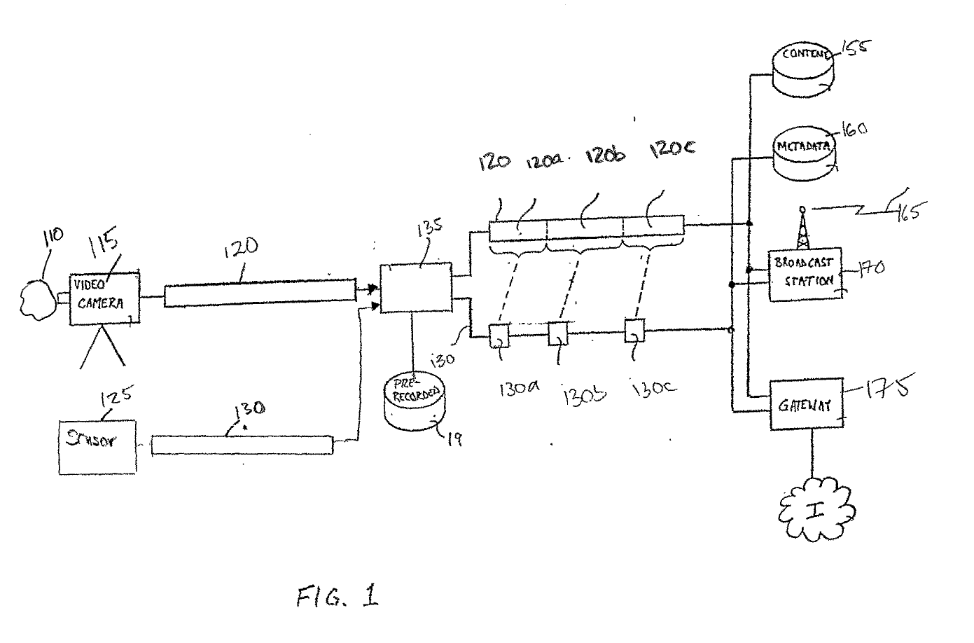

FIG. 1 illustrates the production end of a simplified audio/visual system. In one embodiment, a video camera 115 produces a signal containing an audio/visual data stream 120 that includes images of an event 110. The audio/visual recording device in one embodiment includes the video camera 115. The event 110 may include sporting events, political events, conferences, concerts, and other events which are recorded live. The audio/visual data stream 120 is routed to a tag generator 135. A metadata module 125 produces a signal containing a metadata stream 130. The metadata module 125 observes attributes of the event 110 to produce either automatically or with outside guidance the metadata stream 130. The attributes described by the metadata stream 130 include location information, description of the subject, forces applied on a subject, triggers related to the subject, and the like; these attributes are represented in the metadata stream 130. The metadata stream 130 corresponds to an associated audio video stream 120 and is routed to the tag generator 135.

In one embodiment, the triggers related to the subject provide instructions that correspond to the viewing of the subject when certain conditions are met. For example, an advertisement billboard around a race track may have a trigger associated with the billboard that instructs the billboard to be displayed when the race cars approach their final lap. [more about triggers here]

In another embodiment, the audio visual data stream 120 may be a virtual production that does not rely on a real event to provide content for the audio visual data stream 120. The audio visual data stream 120 may be an animation created by using computer aided tools. Further, the metadata stream 130 may also describe these animated creations.

The tag generator 135 analyzes the audio/visual data stream 120 to identify segments within the audio/visual data stream 120. For example, if the event 110 is an automobile race, the audio/visual data stream 120 contains video images of content segments such as a car racing around a race track while advertisement billboards are shown in the background around the track, advertisement decals are shown in the race cars, and signage shown on the ground of the track infield. These content segments are identified in the tag generator 135. Persons familiar with video production will understand that such a near real-time classification task is analogous to identifying start and stop points in audio/visual instant replay are the recording an athlete's actions by sports statisticians.

A particularly useful and desirable attribute of this classification is the fine granularity of the tagged content segments, which in some instances is on the order of one second or less or even a single audio/visual frame. Thus, an audio/visual segments such as segment 120a may contain a very short video clip showing for example a single car pass made by a particular race car driver or a brief view of an advertisement billboard located on the edge of the race track. Alternatively, the audio/visual segment may have a longer duration of several minutes or more. In addition to fine granularity of time, the granularity of the screen or display surface area may be broken down on a pixel level.

Once the tag generator 135 divides the audio/visual data stream 120 into segments such as segment 120a, segment 120b, and segment 120c, the tag generator 135 processes the metadata stream 130. The tag generator 135 divides the metadata stream 130 into segment 130a, segments 130b, and segment 130c. The metadata stream 130 is divided by the tag generator 135 based upon the segments 120a, 120b, 120c found in the audio/visual data stream 120. The portion of the metadata stream 130 which is within the segments 130a, 130b, and 130c correspond with the portion of the audio/visual data stream 120 within the segments 120a, 120b, and 120c, respectively. The tag generator 135 synchronizes the metadata stream 130 such that the segments 130a, 130b, and 130c correspond with the segments 120a, 120b, and 130c, respectively.

For example, a particular segment within the audio/visual data stream 120 may show images related to a billboard advertisement in the background or foreground. A corresponding segment of the metadata stream 130 contains data from a sensor 125 observing attributes of the advertisement billboard such as the location of the billboard and the identity of the advertiser. In some embodiments, the metadata stream 130 is separate from the audio/visual data stream 120, while in other embodiments the metadata stream 130 and audio/visual data stream 120 are multiplexed together.

In one embodiment, the tag generator 135 initially divides the audio/visual data stream 120 into individual segments and subsequently divides the sensory data stream 130 into individual segments which correspond to the segments of the audio/visual data stream 120. In another embodiment, the tag generator 135 initially divides the metadata stream 130 into individual segments and subsequently divides the audio/visual data stream 120 into individual segments which correspond to the segments of the metadata stream 130.

In order to determine where to divide the audio/visual data stream 120 into individual segments, the tag generator 135 considers various factors such as changes between adjacent images, changes over a group of images, and length of time between segments. In order to determine where to divide the metadata stream 130 into individual segments, the tag generator 135 considers various factors such as change in recorded data over any period of time and the like.

In various embodiments the audio/visual data stream 120 is routed in various ways after that tag generator 135. In one instance, the images in the audio/visual data stream 120 are stored in a content database 155. In another instance, the audio/visual data stream 120 is routed to commercial television broadcast stations 170 for conventional broadcast. In yet another instance, the audio/visual data stream 120 is routed to a conventional Internet gateway 175. Similarly, in various embodiments, the metadata within the metadata stream 130 is stored into metadata database 160, broadcast through the transmitter 117, or broadcast through the Internet gateway 175. These content and metadata examples are illustrative and are not limiting. For example the databases 155 and 160 may be combined into a single database, but are shown as separate elements in FIG. 1 for clarity. Other transmission media may be used for transmitting audio/visual and/or metadata. Thus, metadata may be transmitted at a different time, and to be at a different transmission medium, than the audio/visual data.

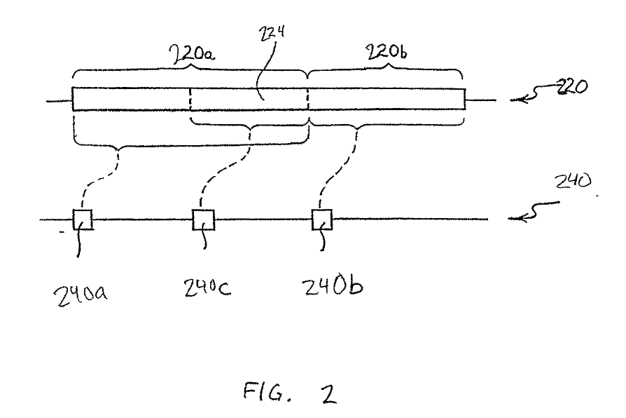

FIG. 2 shows an audio/visual data stream 220 that contains audio/visual images that have been processed by the tag generator 135 (FIG. 1.) A metadata stream 240 contains the metadata associated with segments and sub segments of the audio/visual data stream 220. The audio/visual data stream 220 is classified into two content segments (segment 220a and segment 220b.) An audio/visual sub segment 224 within the segment 220a has also been identified. The metadata stream 240 includes metadata 240a that is associated with the segment 220a, metadata 240b that is associated with the segment 220b, and metadata 220c data associated with sub segment 224. The above examples are shown only to illustrate different possible granularity levels of metadata. In one embodiment the use of multiple granularity levels of metadata is utilized identify and specific portion of the audio/visual data.

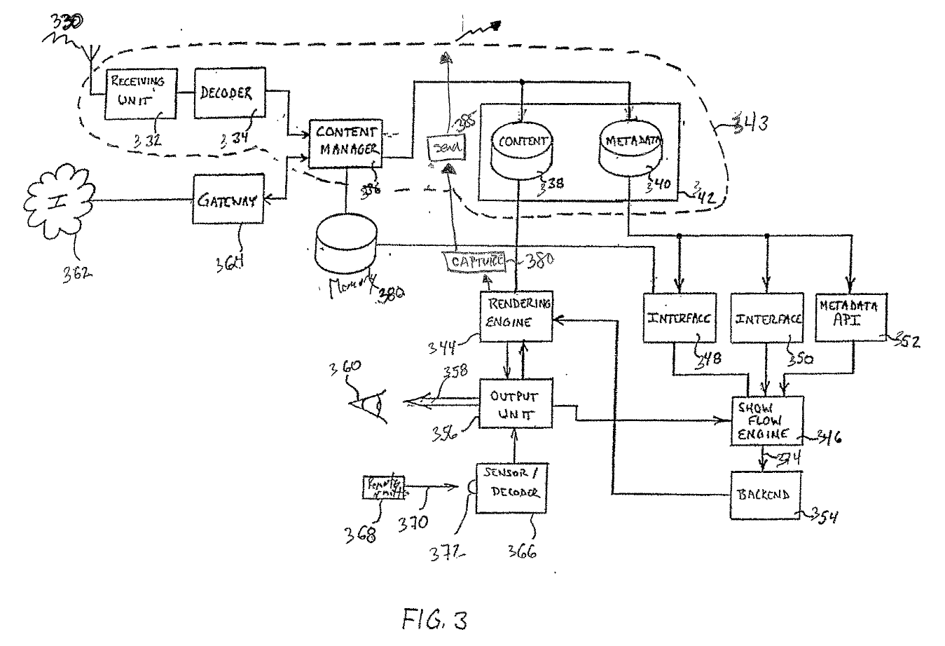

FIG. 3 is a view illustrating one embodiment of the video processing and output components at the client. Audio/visual content and metadata are initiated with the video content and contained in signal 330. Conventional receiving unit 332 captures the signal 330 and outputs the captured signal to conventional decoder unit 334 that decodes the audio/visual content and metadata. The decoded audio/visual content and metadata from the unit 334 are output to content manager 336 that routes the audio/visual content to content storage unit 338 and the metadata to the metadata storage unit 340. The storage units 338 and 340 are shown separately to more clearly describe the invention, but in some embodiments units 338 and 340 are combined as a single local media cache memory unit 342. In some embodiments, the receiving unit 332, the decoder 334, the content manager 336, and the cache 342 are included in a single audiovisual combination unit 343.

The audio/visual content storage unit 338 is coupled to video rendering engine 344. The metadata storage unit 340 is coupled to show flow engine 346 through one or more interfaces such as application software interfaces 348 and 350, and metadata applications program interface 352. The metadata applications program interface 352 gives instructions to the show flow engine 346 to forward to the rendering engine 344 to show certain segments to the viewer 360. For example, the metadata applications program interface 352 executes a trigger found within the metadata storage 340 and forwards these instructions to the show flow engine 346.

Show flow engine 346 is coupled to rendering engine 344 through one or more backends 354. Video output unit 356 is coupled to rendering engine 344 so that audio/visual images stored in storage unit 338 to the output as program 358 to viewer 360. Since in some embodiments output unit 356 is a conventional television, viewer 360's expected television viewing environment is preserved. In other embodiments, the output unit 356 is a computer screen. Preferably, the output unit 356 is capable of being interactive such that the content is able to be selected.

In some embodiments the audio/visual content and/or metadata to be stored in the cache 342 is received from a source other than the signal 330. For example, the metadata may be received from the Internet 362 through the conventional Internet gateway 364. In some embodiments, the content manager 336 actively accesses audio/visual content and/or metadata from the Internet and subsequently downloads the access to material into the cache 342.

In some embodiments, the optional sensor/decoder unit 366 is coupled to the rendering engine 344 and/or to the show flow engine 346. In these embodiments, the viewer 360 utilizes a remote transmitter 368 to output one or more commands 370 that is received by the remote sensor 372 on the sensor/decoder unit 366. The unit 366 relays the decoded commands 370 to the rendering engine 344 or to the show flow engine 346, although in other embodiments the unit 366 may relate decoded commands directly. Commands 370 include instructions from the user that control program 358 audio/visual content, such as skipping certain video clips or accessing additional video clips as described in detail below. Commands 370 may also include instructions from the user to navigate different sections of a virtual game program.

The show flow engine 346 receives the metadata that is associated with available stored audio/visual content such as content locally stored in the cache 342 or that is available through the Internet 358. The show flow engine 346 then uses that metadata to generate program script output 374 to the rendering engine 344. This program script output 374 includes information identifying the memory locations of the audio/visual segments associated with the metadata. In some instances, the show flow engine 346 correlates that metadata with the user preferences stored in preference memory 380 to generate the program script output 374. Since the show flow engine 346 is not processing audio/visual information in real-time, the show flow engine 346 includes a conventional microprocessor/microcontroller (not shown) such as a Pentium® class microprocessor. User preferences are described in more detail below. The rendering engine 344 may operate using one of several languages (e.g. VRML, HTML, MPEG, JavaScript), and so backend 354 provides the necessary interface that allows the rendering engine 344 to process instructions in the program script 374. Multiple backends 354 may be used if multiple rendering engines of different languages are used. Upon receipt of the program script 374 from the show flow engine 346, the rendering engine 344 accesses audio/visual content from the audio/visual content storage unit 338 or from another source such as the Internet 362 and that outputs the access to audio/visual content portions to the viewer 360.

It is not required that all segments of live or prerecorded audio/visual content be tagged. Only those data segments that have specific predetermined attributes are tagged. The metadata formats are structured in various ways to accommodate the various action rates associated with particular televised live events, prerecorded production shows, or virtual gaming programs. The following examples are illustrative and skilled artisans will understand that many variations exist.

Viewer preferences are stored in the preferences database 380. These preferences identify topics have specific interest to the viewer. In various embodiments the preferences are based on the viewer 360's viewing history or habits, direct input by the viewer 360, and predetermined or suggested input from outside the client location.

The fine granularity at tagged audio/visual segments and associated sensory data allows the show flow engine 346 to generate program script that are subsequently used by the rendering engine 344 to output many possible customized presentations or programs to the viewer 360. Illustrated embodiments of such customized presentations or programs are discussed below.

Some embodiments of customized program output 358 are virtual television programs. For example, audio/visual segments from one or more programs are received by the content manager 336, combined and outputted to the viewer 360 as a new program. These audio/visual segments are accumulated over a period of time, and some cases on the order of seconds and in other cases as long as a year or more. For example, useful accumulation periods are one day, one week, and one month, thereby allowing the viewer to watch and daily weekly or monthly virtual program of particular interests. Further, the content audio/visual segments used in the new program can be from programs received on different channels. One result of creating such a customize output is that content originally broadcast for one purpose can be combined and output for different purpose. Thus the new program is adapted to the viewer 360's personal preferences. The same programs are therefore received a different client locations, but each viewer at each client locations sees a unique program that is native segments of the received programs and his customized to conform with each viewer's particular interests.

Another embodiment of the program output 358 is a condensed version of a conventional program that enables the viewer 360 to view highlights of the conventional program. During situations in which the viewer 360 tunes to the conventional program after their program has begun, the condensed version is a summary of preceding highlights. This summary allows the viewer 360 to catch up with the conventional program in progress. Such a summary can be used, for example, for live sports events or prerecorded content such as documentaries. The availability of a summary encourages the viewer to tune and continue watching the conventional program even if the viewer has missed an earlier portion of the program. Another situation, the condensed version is used to receive particular highlights of the completed conventional program without waiting for a commercially produced highlight program. For example, the viewer of a baseball game views a condensed version that shows, for example, game highlights, highlights of the second player, or highlights from two or more baseball games. Such highlights are selected by the viewer 360 using commands from remote transmitter 368 in response to an intuitive menu interface displayed on output 356 in one embodiment. The displayed menu allows viewer 360 to select among, for example, highlights of a particular game, of the particular player during the game, or of two or more games. In some embodiments the interface includes one or more still frames that are associated with the highlighted subject.

Another embodiment, the condensed presentation is tailored to an individual viewer's preferences by using the associated metadata to filter the desired event portion categories in accordance with the viewer's preferences. The viewer's preferences are stored as a list of filter attributes in the preferences memory 380. The content manager compares attributes in received sensory data with the attributes in the filter attribute list. If the received sensory data attribute matches a filter attribute, the audio/visual content segment that is associated with the sensory data is stored in the local cache and 342. Using the car racing example, one viewer may wish to see pit stops and crashes, while another viewer may wish to see only content that is associated with particular driver throughout the race. As another example, a parental rating is associated with video content portions to ensure that some video segments are not locally recorded.

In yet another embodiment, the program output 358 is a virtual gaming program such as a video game. In this embodiment, the viewer 360 may control the direction of the program output 358 by making decisions within the video game. As the video game progresses, the viewer 360 controls the path of the video game and thus what is seen by the viewer 360. The viewer 360 interracts with the video game and guides the actual program output 358.

The capacity to produce virtual or condensed program output also promotes content storage efficiency. If the viewer 360's preferences are to see only particular audio/visual segments, only those particular audio/visual segments are stored in the cache 342. As result, storage efficiency is increased and allows audio/visual content that is of particular interest to the viewer to be stored in the cache 342. The metadata enables the local content manager 336 to locally store video content more efficiently since the condensed presentation is not require other segments of the video program to be stored for output to the viewer. Car races, for instance, typically contain times when no significant activity occurs. Interesting events such as pit stops, crashes, and lead changes occur only intermittently. Between these interesting events, however, little occurs as a particular interest to the average race viewer.

A capture module 380 is coupled to the rendering engine 344 and is configured to monitor the program output 358 to the viewer 360. [should the capture module be coupled to the show flow engine instead???] The capture module 380 watches for preselected metadata parameters and captures data relating to the preselected metadata parameters. The captures module 380 is coupled to a sender module 385. The data related to the preselected metadata parameters are sent to a remote location via the sender module 385.

In one example, the capture module 380 is configured to capture advertising placements seen by the viewer 360. The capture module 380 saves and transmits the data related to the advertising placements which are constructed by the rendering engine 344 and seen by the viewer 360.

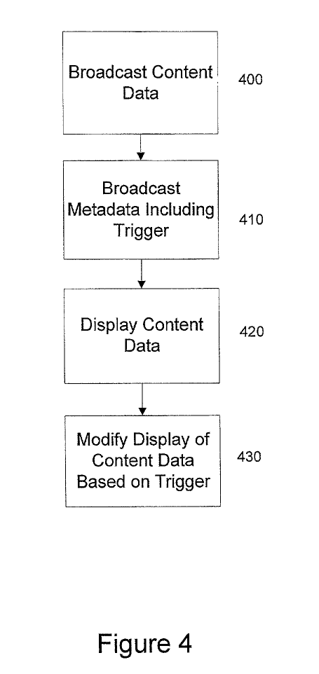

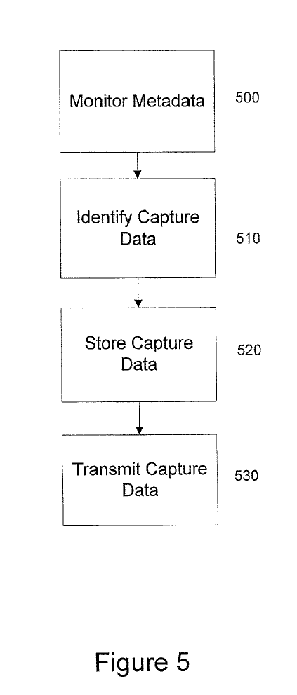

The flow diagrams as depicted in FIGS. 4 and 5 are merely one embodiment of the invention. The blocks may be performed in a different sequence without departing from the spirit of the invention. Further, blocks may be deleted, added or combined without departing from the spirit of the invention.

The flow diagram in FIG. 4 illustrates the use of triggers as metadata in the context of one embodiment of the invention. In Block 400, visual data is broadcasted. In Block 410, metadata that corresponds to the visual data is broadcasted. This metadata includes a trigger that corresponds to the visual data. The trigger contains instructions regarding the viewing of the visual data. In Block 420, the visual data is configured to be displayed to a viewer. In Block 430, the visual data being displayed to the viewer is modified in response to the instructions contained within the trigger.

In one embodiment, the visual data corresponds to a video game which is related to a car racing game. There is a trigger that instructs different advertisement billboards to be displayed on the side of the race track. In one embodiment, the trigger instructs a particular advertisement to be displayed for different laps. This way, advertisers can be assured that their advertising billboards will be displayed during various stages to the user for the duration of the video game. The trigger allows the visual data that is viewed by the user to be dynamically configured almost immediately prior to viewing.

The flow diagram in FIG. 5 illustrates the use of the capture module in the context of one embodiment of the invention. In Block 500, the metadata is monitored by the capture module 380 (FIG. 3). In one embodiment, the capture module is configured to monitor the metadata and to selectively identify target data as the corresponding visual data is being displayed to a user. The target subject may include a specific classes of data such as advertisements, specific race car drivers, car crashes, car spinouts, and the like.

In Block 510, the capture module records data that is related to the target subject. This data is referred to as capture data. The capture data may include subject visibility to the user, camera position, duration of the subject visibility, user interaction with the subject, and the like. Subject visibility is dependent on the size of the subject, obstructions blocking the subject, number of pixels of the subject shown to the user, and the like. Various techniques may be utilized for calculations to determine subject visibility. These technique may include speed optimization utilizing bounding boxes, computing visibility of the subject in terms of polygons instead of counting each pixel, and the like.

Additionally, there are many times when a subject is partially visible. A viewability score may be utilized to reflect a quantifiable number reflecting the viewability of the subject. In one embodiment, a visibility factor score of “1” reflects that the subject is entirely viewable to the user, a visibility factor score of “0” reflects that the subject is invisible to the user, and a visibility factor score of a fractional number less than 1 reflect the fractional visibility of the subject to the user. A ratio of subject pixels to total screen pixels represents a scaling factor. In this embodiment, the viewability score is determined by multiplying the scaling factor with the visibility factor score.

In another embodiment, subject visibility is not limited to a visual parameter but also includes other senses such as hearing, smell and touch. Subject visibility can also be determined based being located within a predetermined distance to experience audible data.

In Block 520, the capture data is stored within either the capture module or another device. In Block 530, the capture data is transmitted to a remote device such as a central location. In one embodiment, the capture data is transmitted via a back channel to the central location. In yet another embodiment, the capture data is not stored and is constantly transmitted to remote device.

In one embodiment, the capture data may be an important metric for advertisement effectiveness. Different scoring systems may interpret the capture data and assign various weightings to subject visibility characteristics.

For exemplary purposes, a video game focusing on racing cars is played by a user. The user races his/her car around a race track. Audio/visual data and corresponding metadata describing the audio/visual data is utilized as content source for this video game. The target subject for the capture module is advertising promotions.

In one embodiment, the user utilizes a driver view and experiences this video game from the perspective of an actual race car driver. As the user rounds the corner of the race track in the race car, the user views a billboard advertisement. The view of the billboard advertisement by the user activates the capture module. The capture data is stored by the capture module for later use. In this example, the user may elect to replay or rewind to the view of the billboard advertisement for another look. The user may even decide to pause the video game and click onto the billboard advertisement to access additional information.

In this example, the capture data may include data reflecting the amount of exposure the user had to the billboard on the initial pass, the amount of exposure the user had to the billboard on the subsequent replay/rewind, and the user's access to additional information prompted by clicking the billboard advertisement. Use of the capture data provides supportive evidence that the user viewed and interacted with the advertisement.

In another embodiment, the user playing the video game may elect to utilize a blimp view and experience this video game from the perspective of a blimp viewing the car race from an overhead view. In this embodiment, instead of having the billboard advertisements on the race track walls, the billboard advertisements may be dynamically shown on the infield surface of the race track. As a result of the dynamic “late binding” production of the video game on a local device, the advertisements shown on the infield surface have visibility by the user, whereas the billboard advertisements would not have had visibility. The advertisements are able to be placed where they will be viewed by the user.

In yet another embodiment, a trigger associated with the billboard advertisements and/or infield advertisements provides instructions for placement of the advertisements. These instructions may include physical placements of the advertisements, duration of the placements based on time, duration of placements based on views by the user, and the like.

The foregoing descriptions of specific embodiments of the invention have been presented for purposes of illustration and description. For example, the invention is described within the context of auto racing as merely embodiments of the invention. The invention may be applied to a variety of other theatrical, musical, game show, reality show, and sports productions. The invention may also be applied to video games and virtual reality applications. They are not intended to be exhaustive or to limit the invention to the precise embodiments disclosed, and naturally many modifications and variations are possible in light of the above teaching.

The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

In the claims:

1. A system comprising:
a. a content database for storing content data; and
b. a metadata database for storing metadata corresponding to the content data,
wherein the metadata includes a trigger for providing an instruction for displaying the content data.

2. The system according to claim 1 wherein the content data is visual data.

3. The system according to claim 1 wherein the content data is audio data.

4. The system according to claim 1 further comprising a receiver module coupled to the content database and the metadata database for receiving a signal containing the content data and the metadata from a remote device.

5. The system according to claim 1 further comprising a display module coupled to the content database and the metadata database for organizing an output script in response to the trigger and the metadata describing a corresponding content data.

6. The system according to claim 5 wherein the display module is a show flow engine.

7. A system comprising:
a. a content stream;
b. a metadata stream corresponding to the content stream for describing the content stream; and
c. a capture module configured for monitoring the metadata stream for a target subject and capturing a parameter associated with the target subject.

8. The system according to claim 7 wherein the parameter is a viewability score of the target subject.

9. The system according to claim 7 wherein the parameter is a duration the target subject is viewed by a user.

10. The system according to claim 7 wherein the parameter reflects an amount the target subject is viewed by a user.

11. The system according to claim 7 further comprising a storage module coupled to the capture module for storing the parameter.

12. The system according to claim 7 further comprising a sender module coupled to the capture module for sending the parameter to a remote device.

13. A method comprising:
a. monitoring a metadata stream for a target subject;
b. playing a content stream corresponding to the metadata stream containing the target subject; and
c. identifying capture data related to the target subject.

14. The method according to claim 13 further comprising storing the capture data.

15. The method according to claim 13 further comprising transmitting the capture data to a remote device.

16. The method according to claim 13 further comprising selecting the target subject from a plurality of target subjects.

17. The method according to claim 13 wherein transmitting the parameter occurs through a back channel.

18. The method according to claim 13 wherein the capture data includes a visibility of the target subject.

19. A method comprising:
a. initializing a trigger;
b. broadcasting a metadata stream including the trigger;
c. broadcasting a content stream which corresponds with the metadata stream; and
d. displaying a portion of the content stream in response to the trigger.

20. A computer-readable medium having computer executable instructions for performing a method comprising:
a. monitoring a metadata stream for a target subject;
b. playing a content stream corresponding to the metadata stream containing the target subject; and
c. identifying capture data related to the target subject.
